(19) United States
(12) Patent Application Publication
(10) Pub. No.: US 2025/0237868 A1
(43) Pub. Date: Jul. 24, 2025

(54) WAVEGUIDE ARRANGEMENT

(71) Applicant: DISPELIX OY, Espoo (FI)

(72) Inventor: Kasimir BLOMSTEDT, Espoo (FI)

(73) Assignee: DISPELIX OY, Espoo (FI)

(21) Appl. No.: 18/699,249

(22) PCT Filed: Sep. 8, 2022
(86) PCT No.: PCT/FI2022/050601

§ 371 Date: Apr. 5, 2024

(30) Foreign Application Priority Data
Oct. 8, 2021 (FI) 20216043

(51) Int. Cl. G02B 27/01

(52) U.S. Cl. CPC G02B 27/0172; G02B 2027/0112

(57) ABSTRACT

According to an example aspect of the present invention, there is provided an optical waveguide arrangement comprising an optical system configured to generate a configurable image encoded in a light field, at least one optical waveguide, arranged to receive light from the light field and to convey the light to plural locations in the optical waveguide for release, generating a waveguide-based display, wherein the optical system comprises a set of light sources, each one of the light sources being configured to generate light of a distinct spectral characteristic in visible spectrum, and wherein the optical system is configured to generate a same colour in two angular aspects of the light field using two different combinations of the light sources.

### FIELD

The present disclosure relates to managing coloured light using optical waveguides.

### BACKGROUND

Optical waveguides are capable of conveying optical frequency light. Optical, or visible, frequencies refer to light with a wavelength of about 400-700 nanometres. Optical waveguides have been employed in displays, wherein light from a primary display may be conveyed using one or more waveguides to suitable locations for release for a user's eye or eyes.

Optical waveguide type displays may be worn in head-mounted glasses or helmets, and may be suitable for augmented reality or virtual reality type applications. In augmented reality, a user sees a view of the real world and superimposed thereon supplementary indications. In virtual reality, the user is deprived of his view into the real world and provided instead a view into a software-defined scene.

### SUMMARY

According to some aspects, there is provided the subject-matter of the independent claims. Some embodiments are defined in the dependent claims.

According to a first aspect of the present disclosure, there is provided an optical waveguide arrangement comprising an optical system configured to generate a configurable image encoded in a light field, at least one optical waveguide, arranged to receive light from the light field and to convey the light to plural locations in the optical waveguide for release, generating a waveguide-based display, wherein the optical system comprises a set of light sources, each one of the light sources being configured to generate light of a distinct spectral characteristic in visible spectrum, and wherein the optical system is configured to generate a same colour in two angular aspects of the light field using two different combinations of the light sources.

According to a second aspect of the present disclosure, there is provided a method comprising generating, using an optical system, a configurable image encoded in a light field, receiving light from the light field into at least one optical waveguide and conveying the light to plural locations in the optical waveguide for release, generating a waveguide-based display, wherein the optical system comprises a set of light sources, each of the light sources being configured to generate light of a distinct spectral characteristic in visible spectrum, and wherein the method comprises generating a same colour in two angular aspects of the light field using two different combinations of the light sources.

According to a third aspect of the present disclosure, there is provided an apparatus comprising means for generating, using an optical system, a configurable image encoded in a light field, receiving light from the light field into at least one optical waveguide and conveying the light to plural locations for release in the optical waveguide, generating a waveguide-based display, wherein the optical system comprises a set of light sources, each of the light sources being configured to generate light of a distinct spectral characteristic in visible spectrum, and wherein the optical system is configured to generate a same colour in two angular aspects of the light field using two different combinations of the light sources.

According to a fourth aspect of the present disclosure, there is provided a non-transitory computer readable medium having stored thereon a set of computer readable instructions that, when executed by at least one processor, cause an apparatus to at least generate, using an optical system, a configurable image encoded in a light field, receive light from the light field into at least one optical waveguide and convey the light to plural locations for release in the optical waveguide, generating a waveguide-based display, wherein the optical system comprises a set of light sources, each of the light sources being configured to generate light of a distinct spectral characteristic in visible spectrum, and wherein the set of computer readable instructions is configured to generate, using the optical system, a same colour in two angular aspects of the light field using two different combinations of the light sources.

According to a fifth aspect of the present disclosure, there is provided a computer program configured to cause a method in accordance with the second aspect to be performed.

### BRIEF DESCRIPTION OF THE DRAWINGS

FIG. 1 illustrates an example system in accordance with at least some embodiments of the present invention;

FIGS. 2A and 2B illustrate an example system in accordance with at least some embodiments of the present invention;

FIG. 3 illustrates an example apparatus capable of supporting at least some embodiments of the present invention, and

FIG. 4 illustrates a flowchart of a method in accordance with at least some embodiments of the present invention.

### EMBODIMENTS

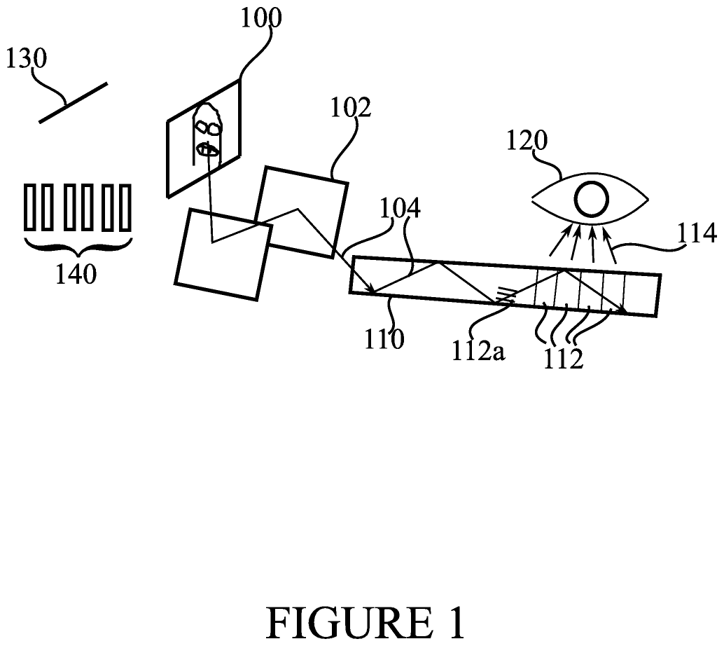

A term “color space” refers to the (two-dimensional) chromaticity diagram corresponding to the perceived colors resulting from the spectral response of an average human eye. The gamut of a device is the region of the color space, which is reproducible by that device. Specifically, here the gamut corresponds to the region in color space, which can be reproduced by the combination of light sources and waveguides, such as light sources 140 and waveguide 110 in FIG. 1, in the system for light fields that the observer perceives to originate from a focal plane. The Region of Interest, ROI, in turn, refers to a region of color space that is sufficient to reproduce what is perceived as a full color image, but may also correspond to a smaller or larger region of color space. As a specific point in the color space can be reached by different combinations of wavelengths, a specific ROI can be reached using different combinations of distinct spectral characteristics, such as peaks in visible spectrum.

A color image may be generated, for example by assuming the user's color vision perception corresponds to a standard eye and by reproducing (a part of) the corresponding color space. As is clear from the definition of the color space, the user perceives the same color as the result of several different light signal spectra. This provides degrees of freedom to how a waveguide operates. In addition, different combinations of distinct spectral characteristics, such as wavelengths, may be used to generate the same color, or a perception of the same color. For example, in reference to CIE color space. In general, the user may perceive a same color from more than one spectrum of light signals. This yields degrees of freedom in manufacturing a waveguide.

By using more than three light sources, such as lasers or light emitting diodes, LEDs, an enhanced waveguide-based display may be constructed, as will be described herein below. In detail, using a set containing more than three visible light sources to generate a single perceived colour on a waveguide based display, colour uniformity across an image of the waveguide based display may be enhanced, since colour propagation errors in the waveguide, or waveguides, may be pre-compensated or at least partly avoided by using an appropriate combination of wavelengths from the set of visible light sources to generate the colour that it is desired to provide to the user in a given location of the waveguide based display. For example, a certain shade of red may be generated using a set of a first red, a first green and a first blue in one part of the waveguide based display, and by using a second red, the first green and a second blue in another part of the waveguide based display. Typically, however, a more complicated mixture of wavelengths will be in use. In detail, each of the light sources may generate a spectrum of light with one or more peaks, and colours are generated using different combinations of these light sources. The user is thereby presented with a more uniform and reliable image over the area of the waveguide based display. The spectrum generated by a light source may be referred to as a spectral characteristic, be it a monochromatic, narrow-band, wideband or multiple-peak spectral output. By monochromatic it may be meant, for example, that the bandwidth of light produced by the light source is narrower than 0.1 nanometres, or narrower than two nanometres, for example. In some embodiments, a partial range of colour space is generated, such as where the waveguide-based display is monochromatic. Alternatively, the white point region may be of interest and other parts of colour space are out of scope for the waveguide-based display.

FIG. 1 illustrates an example system in accordance with at least some embodiments of the present invention. The system comprises a set of light sources 140. Light sources 140 may comprise laser or LED light sources, for example, wherein laser sources have the advantage that they are more strictly monochromatic than LEDs. Light sources 140 together with optional mirror 130 are configured to generate a light field in angular space which is usable in causing the waveguide display to generate its image. The image is encoded in the light field. The light field is schematically illustrated in FIG. 1 as field 100. In some embodiments, a physical primary display may display an image of the light field, while in other embodiments the system comprises no physical primary display and the image is merely encoded in the light field which is distributed in angular space. Light 104 from light field 100 may be conveyed directly, or by using optical guides 102 consisting of, for example, mirrors and/or lenses, to an optical waveguide 110. The optical guides 102 are optional in the sense that depending on the specifics of a particular embodiment, they may be absent. In other words, optical guides 102 are not present in all embodiments. To guide light 104 into waveguide 110, an in-coupling structure, such as a partially reflecting mirror, surface relief grating or other diffractive structure may be used to direct incoming light into the waveguide 110, as is known in the art. In some embodiments, light 104 may be in-coupled from the edge of the waveguide.

In waveguide 110, light 104 advances by being reflected repeatedly inside the waveguide, interacting with elements 112a until it interacts with elements 112 which cause it to be deflected from waveguide 110 to air, toward eye 120 as image producing light rays 114. Elements 112a and 112 may comprise partially reflecting mirrors, surface relief gratings or other diffractive structures, for example. Elements 112a may be arranged, for example, to spread light field 100 inside waveguide 110 such that the image of the waveguide display is correctly generated. Light from different angular aspects of light field 100 will interact with the elements 112 so that the light rays 114 will produce the image encoded in light field 100 on the retina of eye 120. Light may interact with elements 112 in distinct sequences, wherein all elements 112 are not necessarily used all the time. Not all of the light needs to necessarily hit all elements 112. Elements 112 cause the light to leave waveguide 110 at an exit location. As a consequence, the user will perceive the image encoded in light field 100 in front of his eyes 120. As waveguide 110 may be, at least in part, transparent, the user may also advantageously see his real-life surroundings through waveguide 110 in case the waveguide-based display is head-mounted, for example. Light is released from waveguide 110 in multiple angles at multiple locations at elements 112 as a consequence of the action of the elements 112a and 112. A colour image is generated, for example by assuming the user's colour vision perception corresponds to a standard eye. In general, the user may perceive a same colour from more than one spectrum of light rays 114. This yields degrees of freedom in manufacturing waveguide 110.

In a waveguide-based display, there may be present plural waveguides 110, conveying light to increase capacity, for example, as well as, optionally, for the user's other eye which is not illustrated in FIG. 1 for the sake of clarity of the illustration.

The light field 100 encoding the image may be generated using an optical system comprising, for example, a mirror 130 and light sources 140. Mirror 130 may comprise, for example, a microelectromechanical, MEMS, mirror which is configured to reflect light from light sources 140, such as lasers, as to generate the image-encoding light field 100 in a controlled manner by, for example, scanning the angular space thereby generating the light field 100 encoding the image. Mirror 130 may therefore be actuated to tilt to different angles so as to direct the light from the light sources 140 to the appropriate parts of the light field 100 in angular space. In some embodiments, the optical system may consist of other types of image generating devices, such as projectors, where the light sources may for example be LEDs and a primary display may be present in the form of an LCOS device. The optical system may, for example, comprise the light sources and MEMS actuators configured to provide light from the light sources to an angular space, thereby generating a light field for input to waveguide 110.

The system illustrated in FIG. 1 comprises six light sources 140. This is an example to which the present disclosure is not limited, rather, there may be fewer than six, or more than six, light sources. In some embodiments, there are at least four light sources. In some embodiments, the system comprises 2-6 light sources. The light sources 140 may be monochromatic in the sense that they produce either a narrow spectral band of light with a single peak wavelength, as in lasers, or their spectral band may be wider, as with LEDs. Light sources with more complicated spectral distributions are also possible. In principle, the colour space that humans can see can be generated by appropriately exciting the light receptors on the retina. Typically this is achieved, by mixing three wavelengths of light, for example at one wavelength in each in the “red”, “green” and “blue” parts of the spectrum. It may also be accomplished by mixing light from three light sources with more complex spectra.

To produce a colour image encoded in the light field 100 in angular space, light sources 140 may, for example, be programmatically controlled. In instances where the mirror 130 is present, light sources 140 and the mirror 130 may be synchronized with each other such that light from light sources 140 illuminates specific angular regions of the angular space in a controller manner so as to produce therein a representation of a colour image which reproduces a still or moving input image received from an external source, such as, for example, a virtual reality or augmented reality computer. The still or moving image received from the external source may comprise a digital image or a digital video feed, for example. The image encoded in light field 100 is thus configurable by provision of a suitably selected input image.

To produce a specific colour at a given aspect in angular space, this given aspect in angular space may be illuminated by a set of one or more light sources 140, or three or more light sources 140. This specific colour is then reproduced by the light rays 114, as light from the given aspect in angular space proceeds in waveguide 110 to an element 112, where it exits at an angle corresponding to the given aspect in angular space.

A challenge in accurately reproducing the image encoded in light field 100 by the light rays 114 follows from the fact that light of different wavelengths and different propagation angles typically has differing transfer functions through the system, which furthermore are functions of the position on the waveguide surface where the light ray exits the waveguide through element 112. Consequently, the colour observed by the eye 120 will not be a perfect reconstruction of the colour in light field 100, and additionally, the error will be a function of both angular direction and exit location-which means that the quality of colour reproduction and intensity change across the image and according to the eye position of the observer. Solutions laid out in the present disclosure set out to alleviate this challenge and to improve colour reproduction in waveguide displays.

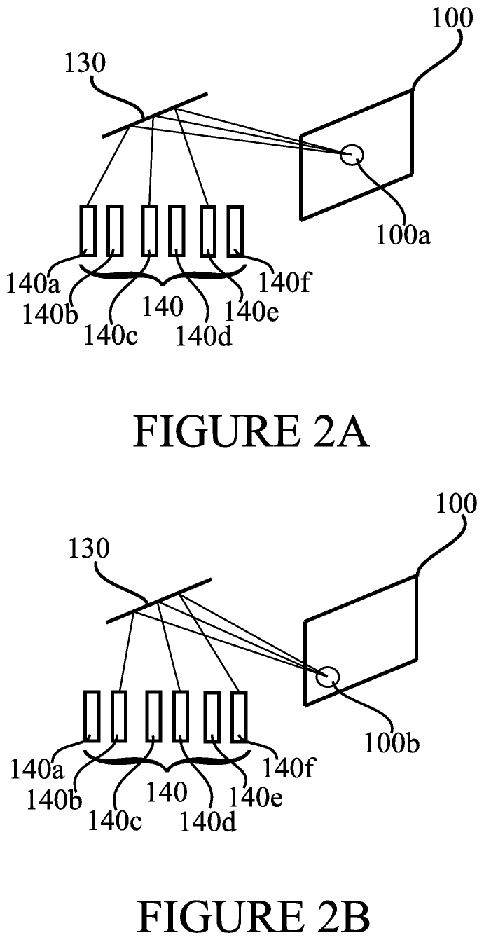

To improve the rendering of the image encoded in light field 100 into directed light 114, a specific colour may be produced in light field 100 using more than one combination of light sources 140. Each used combination may be a different weighted sum of the set of light sources 140. Thus, for example, if it is known how spectra of light in light field 100 change as a function of exit location and angular direction, then wavelength combinations may be selected for colour reproduction which at least in part pre-correct for the spectral changes incurred in the waveguide. This spectral change may be mapped experimentally in advance, for example, to enable its pre-correction in light field 110. This will be illustrated in more detail in connection with FIG. 2. In general, each colour of a range of specific colours may be made in this manner, by using more than one combination of the light sources. One combination of the light sources may be employed in one aspect of light field 100, and another combination of the light sources may be employed to produce the same specific colour in another aspect of light field 100. In some embodiments, the same color in one aspect of the light field 100 may be produced with multiple different combinations of the light sources. For example, identical or nearly identical image perception may be produced with multiple combination of the light sources. In some embodiments, color correction may be realized when optimizing the waveguide structure, making use of the freedom presented by multiple light source combinations in reproducing (essentially) the same color stimuli. Thus, a technical advantage is obtained in increased design flexibility of the waveguide structure.

A programmable control mechanism may be used to automatically choose which combination of light sources to use for which angular aspects of light field 100, to produce a suitable rendering of the image encoded in light field 100 in directed light 114. The programmable control mechanism may be preconfigured with combinations of light sources, which are associated with angular aspects of light field 100. Consequently, using more than e.g. three light sources as light sources 140 provides the technical effect and benefit that image quality provided by a waveguide-based display is improved. This is a consequence of having more component wavelengths to choose from which enables more effective distribution of colour components in the waveguide(s) of the display. A combination of light sources may comprise a linear mixture or a weighted sum of, for example, two, three or four light sources from all of the sources 140. In some embodiments, the combination may be continuous function of angle and/or position. In general, the combination of light sources may comprise from three to up to all light sources 140. The number of light sources 140 may be four, five or six, for example.

In some embodiments, the combinations of light sources used to generate a specific colour each comprise three of light sources 140. In other embodiments, the combinations of light sources used to generate a specific colour each comprise more than three of light sources 140. For example, where light sources 140 comprise more than four light sources, at least one of the sets comprises four light sources from among the more than four light sources, up to all of the light sources 140. In some embodiments, the combinations used comprise weighted combinations of all light sources 140. In some cases, fewer than three light sources may be used to generate a specific colour, depending on the specific colour and the spectra of the light sources. In some embodiments, colour impressions in a sub-part of overall visible colour space may be reproduced using more than one combination of light sources, these combinations each comprising, for example, two light sources.

FIGS. 2A and 2B illustrate an example system in accordance with at least some embodiments of the present invention. Like numbering denotes like structure as in FIG. 1. In FIG. 2A, the six light sources 140 are separately identified as light source 140a, light source 140b, light source 140c, light source 140d, light source 140e, and light source 140f. For example, light sources 140a and 140b may be broadly in the red part of visible spectrum, light sources 140c and 140d may be broadly in the green part of visible spectrum and light sources 140e and 140f may be broadly in the blue part of visible spectrum. In general, the light sources may be in the visible part of spectrum.

In FIG. 2A, light sources 140a, 140c and 140e are used to produce a specific colour in angular aspect 100a of light field 100. The specific colour is determined by the relative powers of the light sources 140a, 140c and 140d, and the brightness of the colour is determined by the sum of powers of these light sources. In the situation of FIG. 2A, light sources 140b, 140d and 140f may be inactive in the sense that they do not emit light. In a more general case, up to all of the light sources may be used to generate the colour at angular aspect 100a, the powers of the light sources being determined by the linear combination weights of the combination used. For example, light sources 140b, 140d and 140f may be present in the combination with only low weights, corresponding to low power levels.

Proceeding then to FIG. 2B, light sources 140b, 140d and 140f are used to produce the specific colour, the same colour as in FIG. 2A, in angular aspect 100b of light field 100. Part 100b is in a different angular part of the light field from where part 100a is. The specific colour is determined by the relative powers of the light sources 140b, 140d and 140f, and the brightness of the colour is determined by the sum of powers of these light sources. In the situation of FIG. 2B, light sources 140a, 140c and 140e may be inactive in the sense that they do not emit light. Again, in a more general case, up to all of the light sources may be used to generate the colour at angular aspect 100b, the powers of the light sources being determined by the linear combination weights of the combination used. For example, light sources 140a, 140c and 140e may be present in the combination with only low weights, corresponding to low power levels. In some embodiments, angular aspects 100a and 100b may correspond to different pixels of an image. A user may perceive the specific colour in angular aspects 100a and 100b as the same colour.

Angular aspects 100a and 100b of light field 100 may be associated with different propagation characteristics for light in waveguides 110, such that light sources may be selectively used for the parts which are well suitable for the respective propagation characteristics, to create a desired visual effect for the user taking the place and/or angle dependency of the propagation characteristics into account. In some embodiments, light field 100 is divided into two or more segments such that a specific sub-set of available light sources, and thus potentially of available wavelengths, is used for each segment. In general, the number of defined segments of light field 100 may be equal to the number of defined combinations of light sources. The same colour may thus be produced using more than one combination of light sources, depending on where in light field 100 and consequently the image of the waveguide display the colour is to be produced.

When encoding a still or video image in light field 100, the angular extent of light field 100 may be scanned in a continuous manner, such that different angular aspects, of light field 100 are scanned using different light source combinations during the continuous scanning. By continuous scanning it is herein meant a repeating process of causing colour elements to be produced throughout an active angular extent of light field 100. In some embodiments, the light sources are not separately configurable for each pixel but for larger image areas. In some embodiments, light sources are configurable separately for each pixel also without scanning. The principles disclosed herein are useful even in embodiments where scanning is not performed.

Although illustrated with six light sources 114, already four light sources enable defining three combinations of three or four light sources from among the four overall light sources. Some colours may be reproducible with one or two light sources, depending on the colour and the spectra of the light source(s). For example, if there are four overall light sources producing, respectively, distinct wavelengths A, B, C and D, this enables constructing sub-sets ABC, ABD, BCD and ACD. Each one of the sub-sets is usable in mixing to produce different visible colours. Alternatively to being switched off, a light source may be configured to contribute to a specific pixel at a low intensity, such as 5% of its maximum intensity, for example. A waveguide-based colour display may be configured to reproduce more or less all of the colours a human can see, or, depending on the embodiment, a subset of the colours a human eye can discern may be sufficient. In some embodiments, a monochrome display may be sufficient. For example, for watching movies, a broad range of colours is needed whereas displaying instruments of a car or aircraft can be accomplished with a more restricted set of colours. More generally, weighted linear combinations of light sources may be used to produce colours, or even just one colour, such that more than one combination may be used to produce a single colour. In some embodiments, all colours used may be produced using more than one combination of the light sources. The light sources may be monochromatic, narrow-band, wideband or have plural spectral peaks as long as they may be mixed to generate the desired range of colours.

One way to generate pixel/angle dependent distributions in non-scanning systems is to synchronize the light sources using micromirror displays, which are liquid-crystal on silicon, LCOS, type displays configurable to set pixels to reflective or off. Normally in these systems colours are implemented by setting the pixels on and off in quick succession synchronized with red, green and blue light source activity times. This works also for larger numbers of light sources.

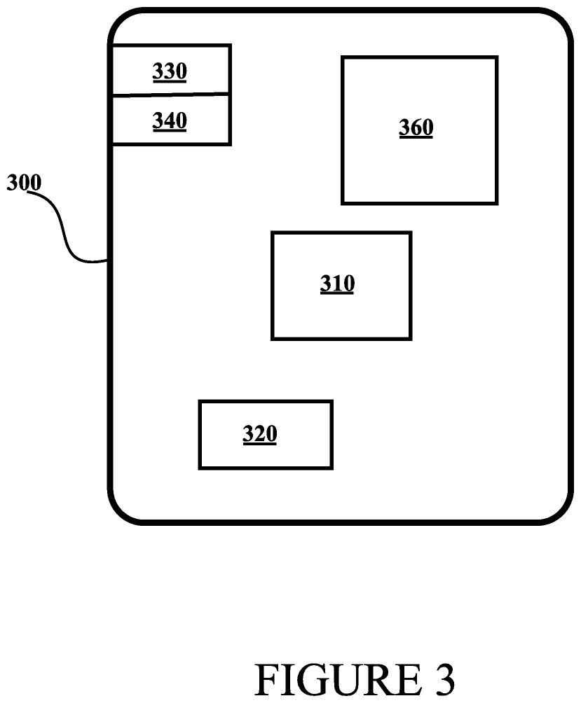

FIG. 3 illustrates an example apparatus capable of supporting at least some embodiments of the present invention. Illustrated is device 300, which may comprise, for example, a control mechanism for operating an arrangement such as one illustrated in FIG. 1 or FIG. 2. Comprised in device 300 is processor 310, which may comprise, for example, a single- or multi-core processor or microcontroller wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Steamroller processing core designed by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300, such as generating, receiving and conveying. Processor 310 may be configured, at least in part by computer instructions, to perform actions.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300. Memory 320 may store information defining segments of primary display 100, for example.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Receiver 340 may be configured to receive an input image, and transmitter 330 may be configured to output control commands to direct mirror 130, where present, and light sources 140, for example, in accordance with the input image.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to configure display parameters.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. In some embodiments, device 300 lacks at least one device described above. For example, some devices 300 may lack a user interface 360.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

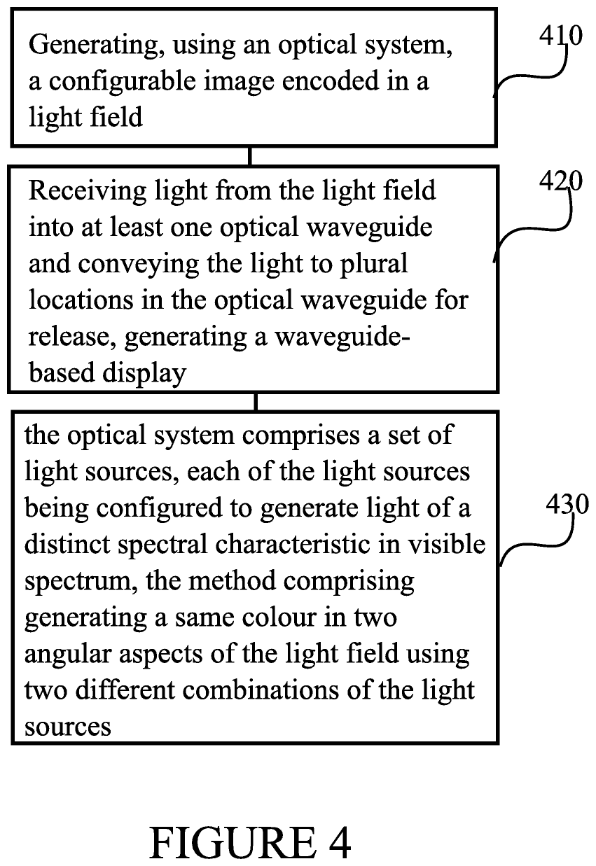

FIG. 4 is a flowchart of a method in accordance with at least some embodiments of the present invention. The phases of the illustrated method may be a waveguide based display, an optical waveguide arrangement in or for a waveguide based display, or in a control mechanism configured to control the functioning thereof, when installed therein.

Phase 410 comprises generating, using an optical system, a configurable image encoded in a light field. Phase 420 comprises receiving light from the light field into at least one optical waveguide and conveying the light to plural locations in each of the at least one optical waveguide for release, generating a waveguide-based display. Finally, phase 430, the optical system comprises a set of light sources, each of the at least four light sources being configured to generate light of a distinct spectral characteristic in visible spectrum, and wherein the method comprises generating a same colour in two angular aspects of the light field using two different combinations of the light sources. The conveying may take place by the optical waveguide, such that the light is conveyed inside the optical waveguide.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in enhancing waveguide displays.

### ACRONYMS LIST

LCOS liquid crystal on silicon
LED light emitting diode
MEMS microelectromechanical

### REFERENCE SIGNS LIST

100 light field
102 optical guides
104 Light
110 Waveguide
112. Elements
114 directed light
120 eye(s)
130 Mirror
140 light sources
140a, 140b, 140c, 140d, 140e, 140f light sources
100a, 100b part of light field 100
300-360 structure of the apparatus of FIG. 3
410-430 phases of the method of FIG. 4

1. An optical waveguide arrangement comprising:
an optical system configured to generate a configurable image encoded in a light field;
at least one optical waveguide, arranged to receive light from the light field and to convey the light to plural locations in the optical waveguide for release, generating a waveguide-based display, wherein
the optical system comprises a set of at least three light sources, each one of the light sources being configured to generate light of a distinct spectral characteristic in visible spectrum, and wherein the optical system is configured to generate a same colour in two angular aspects of the light field using two different weighted combinations of the same light sources of the set.

2. The optical waveguide arrangement according to claim 1, wherein the optical system comprises at least four light sources.

3. The optical waveguide arrangement according to claim 1, wherein the optical system comprises at least four light sources, wherein the optical system is configured to generate a full colour image encoded in the light field.

4. The optical waveguide arrangement according to claim 1, wherein the generating of each distinct spectral characteristic comprises generating a light output with at least one distinct spectral peak.

5. The optical waveguide arrangement according to claim 1, wherein the configurable image comprises a moving image.

6. The optical waveguide arrangement according to claim 1, wherein the at least three light sources comprise laser light sources.

7. The optical waveguide arrangement according to claim 1, wherein the at least three light sources comprise light emitting diode light sources.

8. The optical waveguide arrangement according to claim 1, wherein the optical waveguide arrangement is configured to provide the waveguide-based display as a head-mounted display.

9. A method comprising:
generating, using an optical system, a configurable image encoded in a light field;
receiving light from the light field into at least one optical waveguide and conveying the light to plural locations in the optical waveguide for release, generating a waveguide-based display, wherein
the optical system comprises a set of at least three light sources, each of the light sources being configured to generate light of a distinct spectral characteristic in visible spectrum, and wherein the method comprises generating a same colour in two angular aspects of the light field using two different weighted combinations of the same light sources of the set.

10. The method according to claim 9, wherein the optical system comprises at least four light sources.

11. The method according to claim 9, wherein the optical system comprises four light sources, wherein the method comprises generating a full colour image encoded in the light field.

12. The method according to claim 9, wherein the generating of each distinct spectral characteristic comprises generating a light output with at least one distinct spectral peak.

13. The method according to claim 9, wherein the configurable image comprises a moving image.

14. The method according to claim 9, wherein the at least three light sources comprise laser light sources.

15. The method according to claim 9, wherein the at least three light sources comprise light emitting diode light sources.

16. The method according to claim 9, comprising providing the waveguide-based display as a head-mounted display.

17. An apparatus comprising means for:
generating, using an optical system, a configurable image encoded in a light field;
receiving light from the light field into at least one optical waveguide and conveying the light to plural locations for release in the optical waveguide, generating a waveguide-based display, wherein
the optical system comprises a set of at least three light sources, each of the light sources being configured to generate light of a distinct spectral characteristic in visible spectrum, and wherein the optical system is configured to generate a same colour in two angular aspects of the light field using two different weighted combinations of the same light sources of the set.

18. A non-transitory computer readable medium having stored thereon a set of computer readable instructions that, when executed by at least one processor, cause the apparatus of claim 17 to at least:
generate, using the optical system, a configurable image encoded in a light field;
receive the light from the light field into the at least one optical waveguide and convey the light to the plural locations for release in the optical waveguide, generating the waveguide-based display, and
generate, using the optical system, the same colour in two angular aspects of the light field using two different weighted combinations of the same light sources of the set of at least three light sources.

19. A computer program configured to cause a method in accordance with claim 9 to be performed.
